(19) United States
(12) Patent Application Publication
(10) Pub. No.: US 2005/0174758 A1
(43) Pub. Date: Aug. 11, 2005

(54) "Magic Light" for illumination in handbags

(76) Inventor: Richard Fields, Nokomis, FL (US)

Correspondence Address: Richard Fields, 1075 Sorrento Woods Blvd., Nokomis, FL, 34275, US

(21) Appl. No.: 10/775,625

(22) Filed: Feb. 9, 2004

(51) Int. Cl. F21L 4/04

(52) U.S. Cl. 362/156; 362/155

(57) ABSTRACT

A small light source for handbags which is to be sewn inside the handbag with a zipper accessible compartment. The light circuit consists of thin plastic coated wires, an AAA battery and a battery holder with On/Off switch, a flat light bulb with plastic covering and a normally closed Reed Switch magnet. The wires for the circuit are of a flexible material so that it can be repeatedly bent without harm. Circuit is designed (when battery holder switched on) so that each time the Reed Switch magnet is pulled away from another magnet on the opposite side of the handbag, the light circuit turns on. As the Reed Switch magnet comes into contact with another magnet, the light circuit turns off.

### CROSS-REFERENCE TO RELATED APPLICATIONS

Not Applicable

### FEDERALLY SPONSERED RESEARCH

Not Applicable

### SEQUENCE LISTING OR PROGRAM

Not Applicable

### BACKGROUND OF THE INVENTION

1. Field of Invention

This invention relates to a new concept for illumination in handbags, specifically to such handbags that are carried by women to hold everyday items.

2. Background of the Invention

Handbags are an everyday material item carried by women all over the world. Such handbags are used to carry the most common and necessary of items for everyday usage such as; purses, lipstick, make-ups, toiletries, keys, cell phones, etc. . . .

All handbags today come without any illuminating device inside. There are times in which people carrying handbags may require a light so to see what's inside when there is no other light source available. A light inside the handbag can provide this illumination possible when the owner of the handbag so desires. As of today there are no handbags which today have this resource. Consumers are without this added utility and producers have yet to supply it.

### OBJECTS AND ADVANTAGES

Advantages of the present invention are:
(a) to provide a light source in handbags where there has yet to be one;
(b) to allow easy access for illumination when necessary for handbag owners;

Overall to provide a light utility for consumers where it has yet to exist which can be used easily and conveniently to provide illumination in a handbag, without damage to the bag, which is simple to use and inexpensive to manufacture, which can be used in handbags with magnetic closings, zipper closings or no closing mechanism at all, which can be used at length over the life-span of the (AAA) battery. Such advantages will become apparent with the following description and drawings.

### DRAWINGS—FIGURES

FIGS. 1-4 constitute the parts necessary for the light circuit.

FIG. 1 shows a (AAA) battery holder with an On/Off switch.

FIG. 2 shows a normally closed Reed Switch magnet.

FIG. 3 shows a flat lamp light bulb with plastic cover.

FIG. 4 shows a magnet.

FIG. 5 shows one version of “Magic Light” circuit to illuminate a handbag.

FIG. 6 shows another version of “Magic Light” circuit to illuminate a handbag.

FIG. 7 shows a handbag with a zipper closing mechanism with added “Magic Light” circuit inside.

FIG. 8 shows a handbag with a magnetic closing mechanism with added “Magic Light” circuit inside.

FIG. 9 shows a hand bag with no closing mechanism with added “Magic Light” circuit inside.

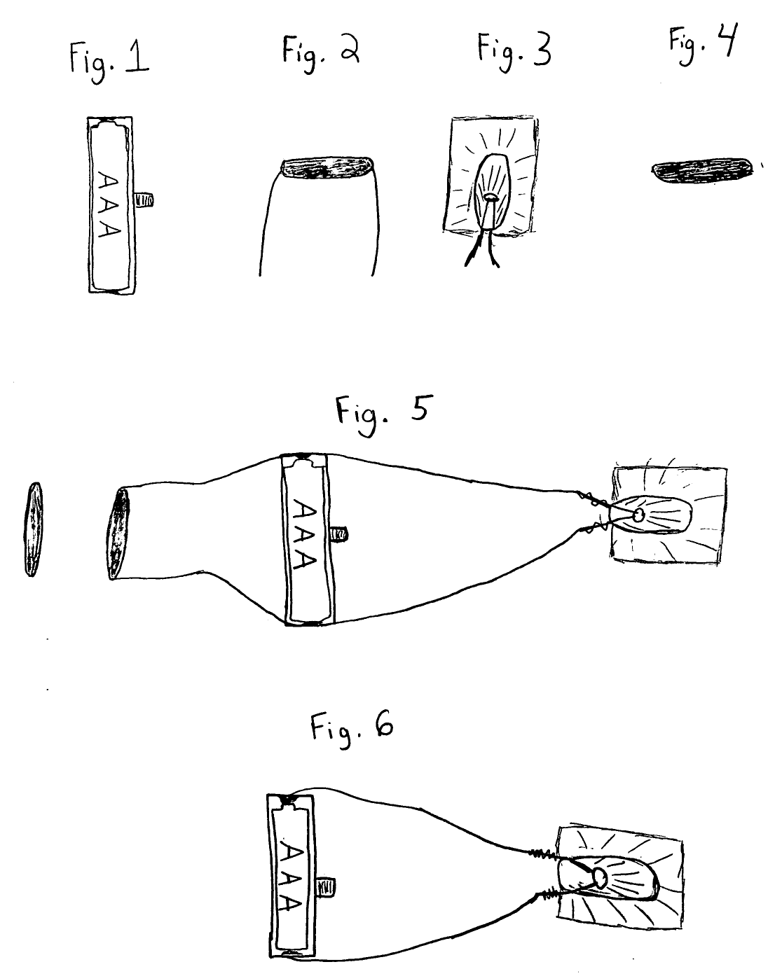

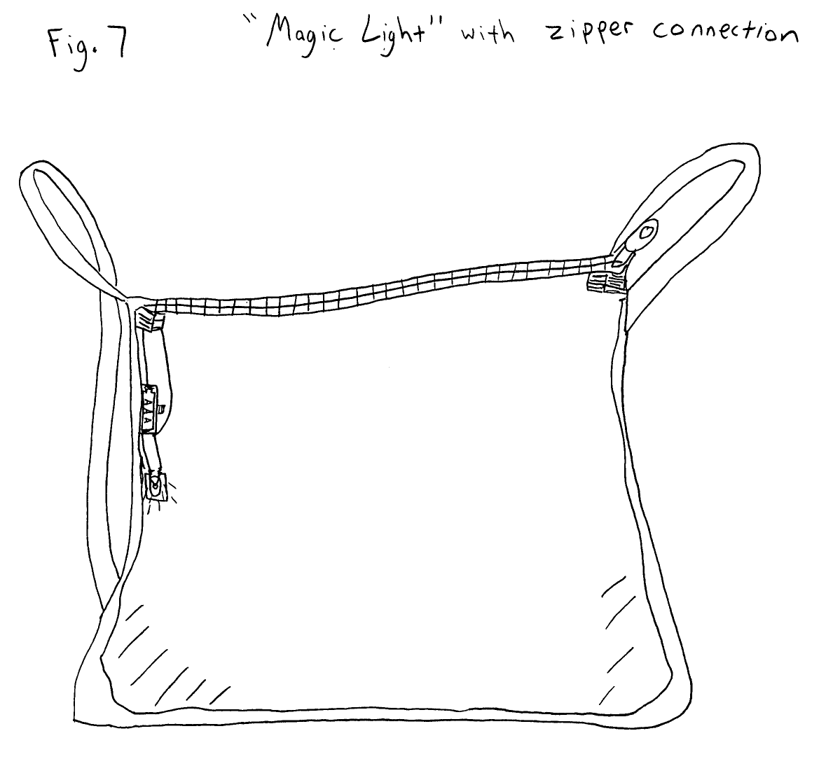

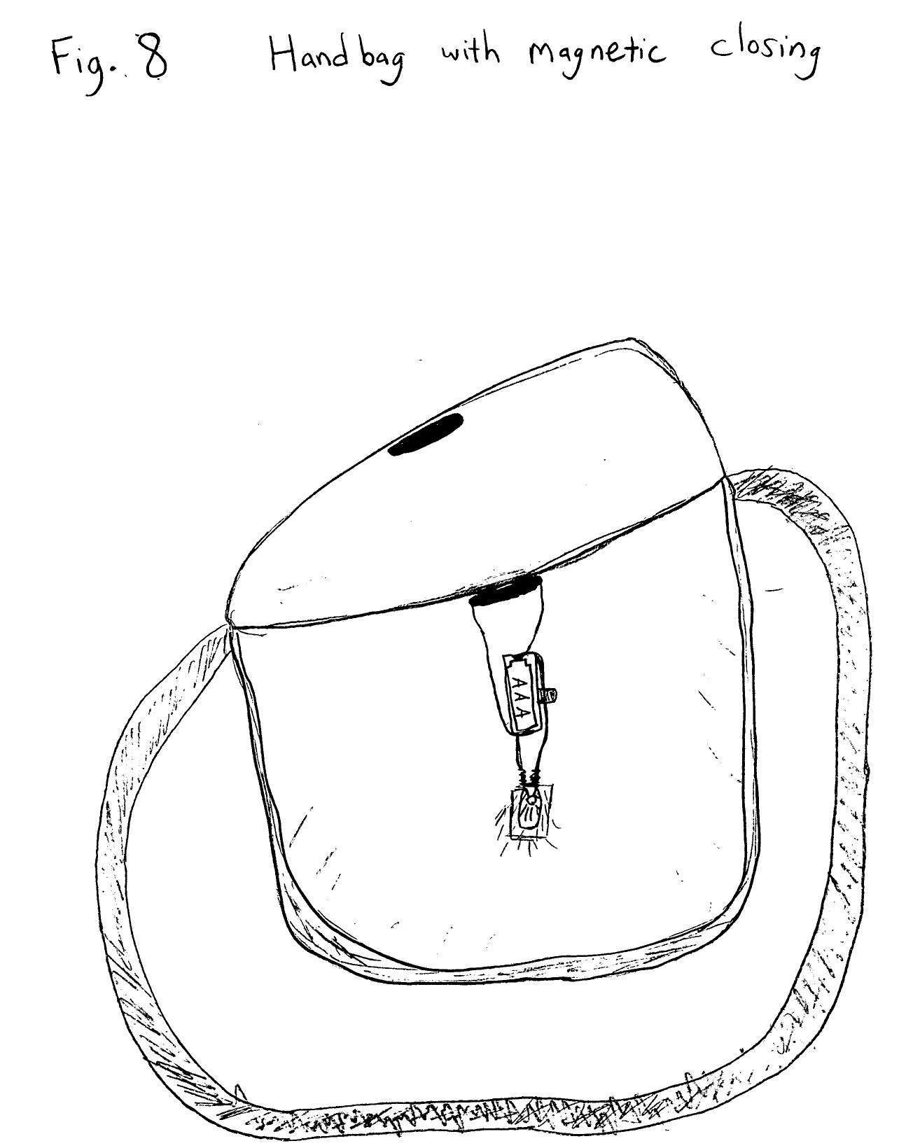

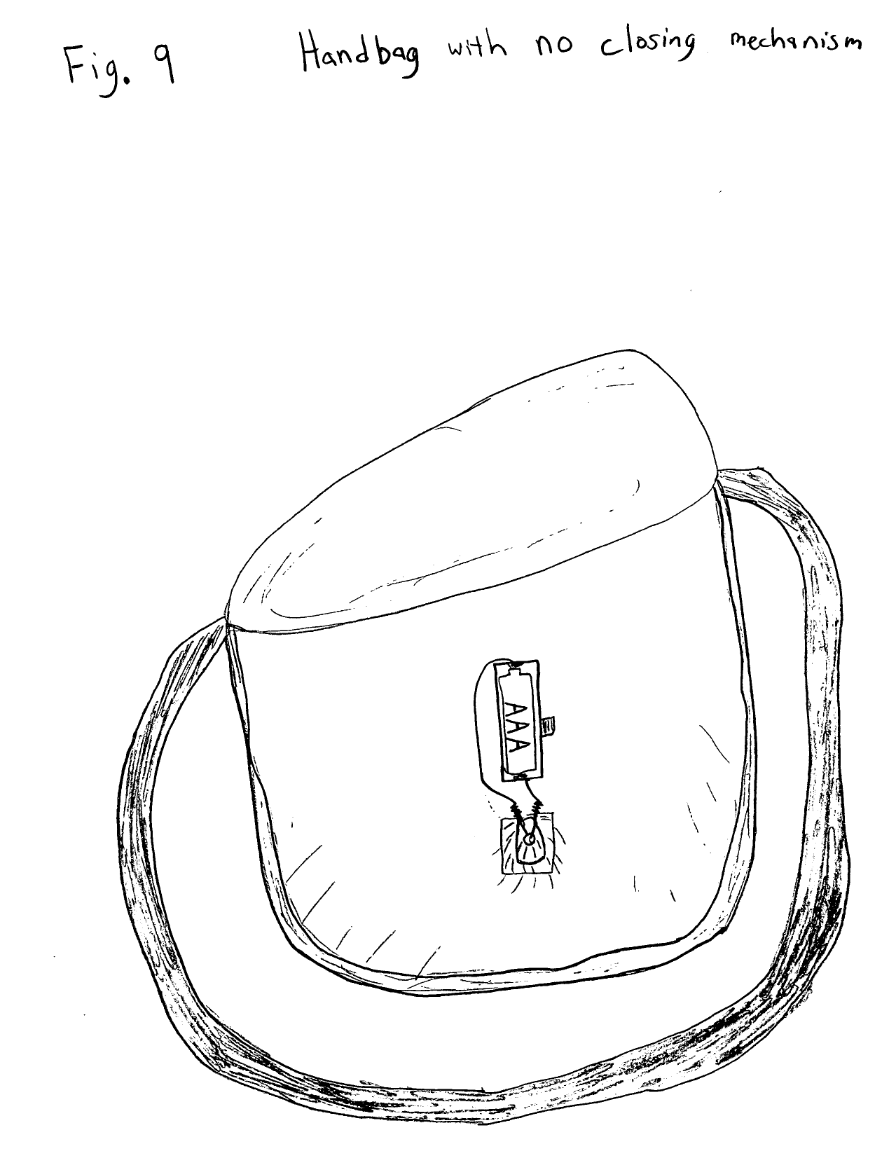

### DETAILED DESCRIPTION AND OPERATION FOR DRAWING FIGS. 5-9

FIG. 5 shows a complete “Magic Light” circuit to be used to illuminate handbags using a magnetic and zipper closing mechanism.

FIG. 6 shows a complete “Magic Light” circuit to be used to illuminate handbags with no closing mechanism.

FIG. 7 shows a handbag with a zipper closing mechanism which has the “Magic Light” (FIG. 5) circuit introduced. When the battery holder is switched to ON, the light will then only illuminate while the zipper is unzipped. The light is caused to illuminate when the Reed Switch magnet and the other magnet are no longer in contact. The light will turn off when the zipper is closed and the Reed Switch magnet comes in contact with the other magnet at the other end of the zipper. Likewise, if the battery holder is switched to OFF, the light will illuminate only when the battery switch is turned to ON. Again, the light will illuminate only when the Reed Switch is not in contact with the other magnet. The owner of the handbag can operate “Magic Light” by solely using the battery holder switch while the bag is open at their leisure.

FIG. 8 shows a handbag with a magnetic closing mechanism which has the “Magic Light” (FIG. 5) circuit introduced. When the battery holder is switched ON, the light will only illuminate when the magnets are not in contact with each other. The light is caused to illuminate when the Reed Switch magnet and the other magnet are not in contact with each other. The light will turn off when the Reed Switch magnet comes in contact with the other magnet. Likewise, if the battery holder is switched to OFF, the light will only illuminate when the battery switch is turned ON while the magnets are not in contact with each other. This gives the owner of the handbag the ability to keep the battery switch ON or OFF while the bag is open, thus giving the owner the ability to use “Magic Light” at their leisure.

FIG. 9 shows a handbag with no closing mechanism whish has the “Magic Light” (FIG. 6) circuit introduced. Since there are no magnets or zippers needed for this handbag, a simple circuit using the battery switch can be utilized. The owner of the handbag with the (FIG. 6) “Magic Light” circuit will have the ability to illuminate the bag by simply turning ON and OFF the battery switch. The light can go on at any time using this circuit at the owner's discretion.

Advantages

(a) To provide a light source in handbags where there has yet to be one;
(b) To allow easy access for illumination when necessary for handbag owners;
(c) To provide superior visibility to handbag owners day or night;
(d) To provide illumination capabilities to owners of all different sizes and styles of handbags with different closing mechanism options.

1. A light circuit with express purpose to illuminate inside a handbag comprising of:
a) wires connecting all components together,
b) an (AAA) battery holder with ON/OFF switch providing current to flow,
c) a small flat lamp light bulb using an AAA battery source,
d) a flat plastic cover over the light bulb to protect against damaging,
e) a normally closed open Reed Switch magnet whereby current can flow unobstructed when not in contact with another magnet. (Expressly needed for handbags using a zipper and magnet closing mechanism)
